(19) United States
(12) Patent Application Publication
(10) Pub. No.: US 2021/0404331 A1
(43) Pub. Date: Dec. 30, 2021

(54) FINE IDENTIFICATION METHOD OF TIGHT RESERVOIR FRACTURE BASED ON CONVENTIONAL LOGGING DATA

(71) Applicant: Southwest Petroleum University, Chengdu City (CN)

(72) Inventors: Hongqi LIU, Chengdu City (CN); Jie TIAN, Chengdu City (CN); Liqiang SIMA, Chengdu City (CN); Shiqiong LIU, Chengdu City (CN); Xiangjun LIU, Chengdu City (CN); Liangang YANG, Chengdu City (CN)

(21) Appl. No.: 17/231,131

(22) Filed: Apr. 15, 2021

(30) Foreign Application Priority Data
Jun. 24, 2020 (CN) 202010591691.2

(51) Int. Cl. E21B 49/00

(52) U.S. Cl. CPC E21B 49/006; E21B 49/005

(57) ABSTRACT

The present disclosure provides a fine identification method of a tight reservoir fracture based on conventional logging data. The method includes: eliminating a logging interference factor from a non-fracture response, choosing a basic lithological background for fracture identification, analyzing logging response features on different fracture scales, analyzing fracture aperture and filling features on a scale that can be identified by conventional logging data, identifying occurrence of an open fracture, and identifying a development degree of a fracture through a relative amplitude difference between a deep resistivity and a bedrock resistivity. The method of the present disclosure is suited for fine evaluation of a tight reservoir fracture. Compared with a traditional method, the present disclosure improves systematicness and geological compliance of conventional logging to identify large-scale fractures, and further analyzes micro-scale fracture identification, providing technical support and an analysis method for tight reservoir development.

### CROSS-REFERENCE TO RELATED PATENT APPLICATION

This non-provisional application claims priority to and the benefit of, pursuant to 35 U.S.C. § 119(a), patent application Serial No. CN202010591691.2 filed in China on Jun. 24, 2020. The disclosure of the above application is incorporated herein in its entirety by reference.

### TECHNICAL FIELD

The present disclosure relates to the technical field of fine identification of tight reservoir fractures, in particular to a fine identification method of a tight reservoir fracture based on conventional logging data.

### BACKGROUND

The development of tight oil is a research hotspot. Most oilfields have long exploration and development history, but their logging usually uses old well data and conventional series, and their density and neutron logging data are insufficient. The evaluation of fractures by conventional logging data is hard to meet the needs of old oilfields for tight oil development. Tight and heterogeneous fractures are generally identified through imaging logging series, but effective identification is rarely achieved through conventional logging curves. Conventional identification fails to conduct complete and systematic evaluation of fractures, and does not reach the micro-nano-scale of tight reservoir development, so it cannot meet the requirements of unconventional exploration and development of tight reservoirs.

In order to perform micro- or nano-scale fine identification and complete and systematic evaluation of fractures through conventional logging, the present disclosure proposes this method.

### SUMMARY

In order to solve the problems existing in the prior art, an objective of the present disclosure is to provide a fine identification method of a tight reservoir fracture based on conventional logging data.

To achieve the above purpose, the present disclosure provides the following technical solutions.

A fine identification method of a tight reservoir fracture based on conventional logging data includes the following steps:

step 1: eliminating an influencing factor of a non-fracture response in a logging curve;

step 2: constraining a lithology of a fracture development section, where the lithology is a background of a logging curve response and controls fracture development; analyzing a basic lithology of a tight reservoir by core and thin section observation and lithification means, where the lithology of the tight reservoir mainly includes limestone, dolomite, sandstone and mudstone; choosing a thick, lithologically developed and stable section, eliminating interference of different lithologies, and looking for a stable logging response background with fracture development;

step 3: identifying a fracture scale: performing a more refined interpretation of a fracture based on a fracture scale that can be identified by conventional logging, that is, constraining the fracture scale;

step 4: dividing the fracture into large and small-scale fractures, and identifying a fracture aperture and filling; determining an aperture of the large-scale fracture by a relative amplitude difference between a deep resistivity Rt and a bedrock resistivity Rb, and roughly determining an aperture of the small-scale fracture by a relative difference of deep and shallow lateral resistivity;

step 5: identifying occurrence of a large-scale open fracture based on the scale and aperture constraints, the fracture being divided into high-angle, low-angle and horizontal fractures; and

step 6: identifying a development degree of large and small-scale open fractures based on the scale and aperture constraints: measuring the large-scale fracture by a fracture linear density, and dividing the small-scale fracture based on high and low development degrees by a fracture porosity derived from a thin section, where a conventional logging curve shows that for both the large and small-scale fractures, a higher development degree leads to a more obvious decrease in the resistivity, and an acoustic value tends to increase as the development degree increases.

Preferably, the step 1 of eliminating an influencing factor of a non-fracture response in a logging curve may include:

(1) eliminating a thin layer response;

(2) eliminating a shale response; and

(3) eliminating a well wall stability response.

Preferably, the step 3 of identifying a fracture scale: performing a more refined interpretation of a fracture based on a fracture scale that can be identified by conventional logging, that is, constraining the fracture scale may include (The fracture scale identification method and features are described by taking a work area as an example):

(1) dividing the fracture scale: dividing the fracture scale into large, small and micro scales by combining core, thin section, scanning electron microscopy and other means;

(2) identifying a large-scale fracture, where under a high-resistivity background, the resistivity shows a tooth-like and finger-like decrease trend, and the resistivity after the decrease is medium-high and less than 3000 Ω·m; an ultrasonic curve often tends to increase, with an acoustic value of greater than 48 μs/ft;

(3) identifying a small-scale fracture, where a resistivity is about 6000 Ω·m, and an acoustic value is low; compared with a bedrock background, a resistivity curve shows a tooth-like downward trend, and often drops into a gap, which is a “platform gap”; and

(4) identifying a micro-scale fracture, where thick limestone has a finger-like resistivity and a small fracture porosity; the resistivity is equal to or close to the bedrock resistivity; due to lithology and thickness differences, the resistivity is often in high-amplitude, medium-amplitude and low-amplitude finger shapes; a gamma curve background is a box-shaped smooth curve, with a very small increase in a corresponding point; the acoustic value curve is smooth, entirely in a box-shaped background; the resistivity is in a high-amplitude finger shape; since the micro-scale fracture has poor connectivity which leads to high conductivity, compared to other rock layer with good connectivity or high shale content, the resistivity in a micro-scale fracture development section is in a finger shape.

Preferably, the step 4 of dividing the fracture into large and small-scale fractures, and identifying a fracture aperture and filling: determining an aperture of the large-scale fracture by a relative amplitude difference between a deep resistivity Rt and a bedrock resistivity Rb, and roughly determining an aperture of the small-scale fracture by a relative difference of deep and shallow lateral resistivity may include:

(1) identifying the aperture of the large-scale fracture, where when the fracture opens, (log R_{b}−log R_{T})/log R_{b} increases, >0.05; when the fracture closes, a deep resistivity of the fracture is very close to the bedrock resistivity, and (log R_{b}−log R_{T})/log R_{b}<0.05;

(2) calibrating the small-scale fracture only through a thin section, where the aperture of the small-scale fracture is only roughly identified based on RT, with a poor identification effect; and

(3) identifying the fracture filling, where a gamma ray (GR) intensity of a shale-filled fracture is significantly higher than that of a calcite-filled fracture, with a dividing line being 20 API; acoustic (AC) logging has a poor identification effect on the filling; the acoustic value of the shale-filled fracture is greater, up to 63 μs/ft, which is equivalent to that of an open fracture; the Rt of the calcite-filled fracture is significantly greater than that of the shale-filled fracture; the resistivity of the shale-filled fracture is higher than an unfilled open fracture; an unfilled fracture has a slightly higher gamma value and a lower resistivity than a filled fracture.

Preferably, the step 5 of identifying occurrence of a large-scale open fracture based on the scale and aperture constraints, the fracture being divided into high-angle, low-angle and horizontal fractures may include:

(1) identifying low-angle and horizontal fractures, where the natural gamma logging curve is box-shaped and smooth; the resistivity often reduces in a sharp peak shape or a tooth shape, with no amplitude difference to slight negative amplitude difference; the acoustic value often increases in a tooth or sharp peak shape; for an oblique fracture, the logging curves show a decrease in the resistivity and a slight increase in the acoustic value; and

(2) identifying a high-angle fracture, where if a high-angle fracture has a low development degree and is mostly filled, a bedrock feature is shown in an entire logging curve, with no obvious response; when the high-angle fracture opens, there is a negative difference between the deep and shallow resistivity of the fracture.

Preferably, the step 6 of identifying a development degree of large and small-scale open fractures based on the scale and aperture constraints: measuring the large-scale fracture by a fracture linear density, and dividing the small-scale fracture based on high and low development degrees by a fracture porosity derived from a thin section, where a conventional logging curve shows that for both the large and small-scale fractures, a higher development degree leads to a more obvious decrease in the resistivity, and an acoustic value tends to increase as the development degree increases may include:

(1) identifying the development degree of the small-scale fracture: dividing the development degree of the small-scale fracture into high and low based on a fracture porosity of 1%, where the development degree of micro and small-scale fractures is high, and a cutoff value of log R_{T}−log R_{XO} is 0.1; and

(2) identifying the development degree of the large-scale fracture, where an analysis finds that the fracture linear density has a good positive correlation with (log R_{b}−log R_{T})/log R_{b}; a greater linear density indicates a greater decrease in the resistivity than the bedrock resistivity; at the same level of acoustic value, a higher fracture linear density indicates a lower resistivity.

The present disclosure has the following advantages:

1. The present disclosure is based on conventional logging data to constrain and identify fracture features step by step, which is different from an existing mathematical identification method. Starting from the principle, the present disclosure uses actual geology and reservoir features as constraints to gradually eliminate interference factors in terms of borehole, thin layer and lithology, and constrains each fracture feature on a logging response platform for comparison. In this way, the present disclosure makes the identification effect in line with geological features and improves the accuracy.

The present disclosure provides a more systematic and complete interpretation of fractures in terms of scale, aperture, filling, occurrence and development degree, and provides a good identification of micro and small-scale fractures, and a fine identification, offering technical support for the development of tight reservoirs.

### BRIEF DESCRIPTION OF DRAWINGS

FIG. 1 is a flowchart of a fine identification method of a tight reservoir fracture based on conventional logging data according to the present disclosure.

FIG. 2 is an aperture identification diagram of the fine identification method of a tight reservoir fracture based on conventional logging data according to the present disclosure.

FIG. 3 is a development degree distribution diagram of the fine identification method of a tight reservoir fracture based on conventional logging data according to the present disclosure.

### DETAILED DESCRIPTION

The technical solutions of the embodiments of the present disclosure are clearly and completely described below with reference to the accompanying drawings. Apparently, the described embodiments are merely a part rather than all of the embodiments of the present disclosure.

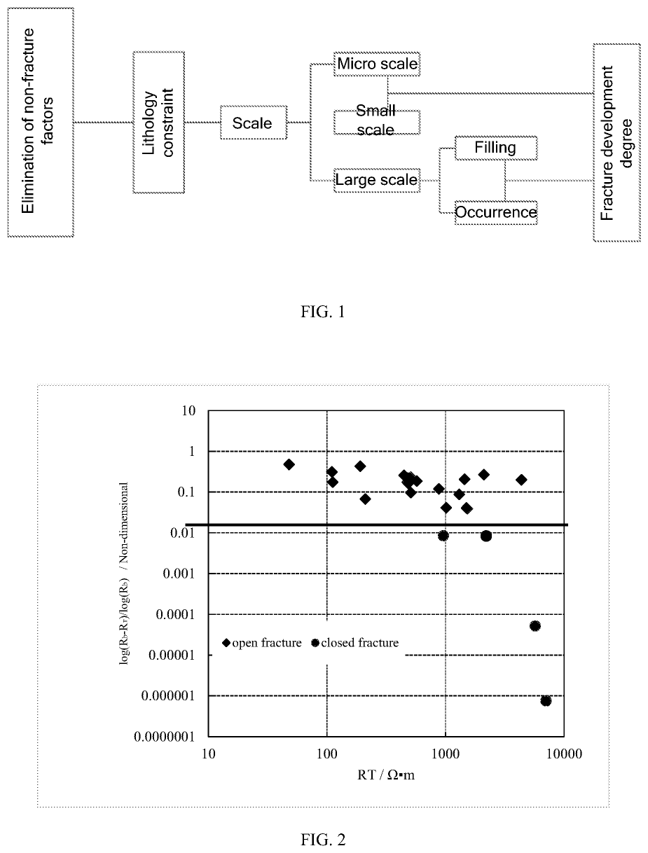

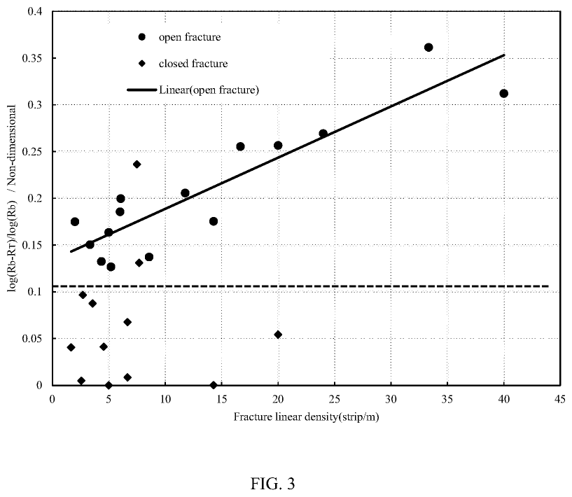

The present disclosure provides a fine identification method of a tight reservoir fracture based on conventional logging. As shown in FIGS. 1 to 3, the fine identification method includes the following steps:

Step 1: Eliminate an influencing factor of a non-fracture response in a logging curve.

(1) Eliminate a thin layer response. Different logging tools have different resolutions to a rock layer thickness. For a rock layer with a thickness beyond the resolution, a value on a logging curve is a real response of the rock layer, and the position of a half-amplitude point corresponds to a boundary line of the rock layer. Generally, the resolution of natural gamma logging (GR) is about 30 cm; the resolution of compensated acoustic logging is 60 cm for limestone and about 100 cm for mudstone; the resolution of compensated neutron logging is about 40 cm; the resolution of dual lateral logging is about 80 cm. Considering the resolution factor, a rock layer with a thickness greater than 1 m is chosen for fracture identification. The logging value of a thin layer is affected by a surrounding rock and basically cannot represent the real response feature of the rock layer.

(2) Eliminate a shale response. For a pelitic strip or a lithological abrupt section with an increased shale content, a fracture-like response will appear on the acoustic, resistivity, neutron and density curves. That is, an acoustic value increases, a neutron value increases, a density value decreases, and a resistivity value decreases significantly. The response needs to be eliminated through the combination of gamma and acoustic curves. For a shale-filled fracture, the resolution of a gamma curve is much larger than the fracture width due to the small fracture width. Except for a shale-filled fracture concentrated zone, the gamma curve has no obvious response to the shale-filled fracture, and it appears in a smooth box or micro-toothed box shape. For the pelitic strip, the gamma curve has a significant increase, and the acoustic curve has a significant increase in a tooth-finger shape.

(3) Eliminate a well wall stability response. During drilling, due to factors such as geological structure, in-situ stress of the formation and weak structural discontinuities, a borehole wall will become unstable. In a borehole expansion section, the acoustic wave, density and neutron will all be affected. Due to the low density, high acoustic wave and high hydrogen index of mud, the measured acoustic value will increase, the density will decrease, and the neutron value will increase. In a severely expanded section of a borehole, the resistivity value will also decrease, generating a fracture-like feature. This type of interference can be eliminated through a wellbore diameter curve.

Step 2: Constrain a lithology of a fracture development section, where the lithology is a background of a logging curve response and controls fracture development; analyze a basic lithology of a tight reservoir by core and thin section observation and lithification means, where the lithology of the tight reservoir mainly includes limestone, dolomite, sandstone and mudstone; choose a thick, lithologically developed and stable section, eliminate interference of different lithologies, and look for a stable logging response background with fracture development.

(1) Sandstone: Primary and secondary intergranular pores are mainly developed, and no fracture is developed.

(2) Mudstone: A reservoir space is mainly composed of pores between grains of clay minerals and dissolved pores within grains, with small pore diameters. There are no or few fractures in the mudstone. Fractures are mainly developed at a lithological interface (for example, pressure-dissolved fractures are easy to develop in a calcilutite interface). Due to the thin interlayered lithology and thin overall thickness, it is hard for the logging curve to reflect a real response. Therefore, the fractures in the mudstone section and interval are not identified.

(3) Limestone: A dominant lithology of a tight reservoir is limestone, which has a skeleton of shells and calcite crystals. The shells are mainly from bivalves and gastropods. The original biological skeleton is composed of carbonate minerals, including aragonite and calcite. In the process of burial diagenesis, primitive aragonite and high-magnesium calcite are transformed into low-magnesium calcite. Due to the rock skeleton with pure lithology, calcite content and low shale content, the lithology of the limestone shows a high overall resistivity on the logging curve. The reservoir space of limestone mainly develops secondary pores. A macroscopically visible pore size (minority) is larger than 50 μm. The pore size of dominant micro-pores is between 1 μm and 50 μm. The widespread development of micro-nano-scale reservoir space results in physical properties with an overall porosity lower than 2% and a permeability lower than 0.1×10⁻³ μm². The physical properties of ultra-low porosity and low permeability further increase the resistivity and reduce the acoustic value.

Due to the high calcite, low shale content lithology and ultra-low physical properties, the resistivity of limestone is generally greater than 5000 Ω·m, the acoustic value is close to that of the limestone skeleton which is about 47.5 μs/ft, the natural gamma value is obviously low, and the neutron and density values are close to a theoretical value of the skeleton. For thick limestone, the conventional logging curve basically has a box shape, and changes smoothly or in a micro-tooth shape.

(4) Dolomite: The response of the logging curve is similar to that of limestone, and the fracture identification principle is similar to that of limestone. In this patent, it is treated as limestone.

Step 3: Identify a fracture scale: perform a more refined interpretation of a fracture based on a fracture scale that can be identified by conventional logging, that is, constrain the fracture scale. The fracture scale identification method and features are described by taking a work area as an example.

Step 4: Divide the fracture into large and small-scale fractures, and identify a fracture aperture and filling: determine an aperture of the large-scale fracture by a relative amplitude difference between a deep resistivity Rt and a bedrock resistivity Rb, and roughly determine an aperture of the small-scale fracture by a relative difference of deep and shallow lateral resistivity.

(1) Identify the aperture of the large-scale fracture. When the fracture opens, (log R_{b}−log R_{T})/log R_{b} increases, >0.05; when the fracture closes, a deep resistivity of the fracture is very close to the bedrock resistivity, and (log R_{b}−log R_{T})/log R_{b}<0.05.

(2) Calibrate the small-scale fracture only through a thin section. The aperture of the small-scale fracture is only roughly identified based on RT, with a poor identification effect.

(3) Identify the fracture filling. A gamma ray (GR) intensity of a shale-filled fracture is significantly higher than that of a calcite-filled fracture, with a dividing line being 20 API. Acoustic (AC) logging has a poor identification effect on the filling. The acoustic value of the shale-filled fracture is greater, up to 63 μs/ft, which is equivalent to that of an open fracture. The Rt of the calcite-filled fracture is significantly greater than that of the shale-filled fracture. The resistivity of the shale-filled fracture is higher than an unfilled open fracture.

Step 5: Identify occurrence of a large-scale open fracture based on the scale and aperture constraints, the fracture being divided into high-angle, low-angle and horizontal fractures.

(1) Identify low-angle and horizontal fractures. The natural gamma logging curve is box-shaped and smooth. The resistivity often reduces in a sharp peak shape or a tooth shape, with no amplitude difference to slight negative amplitude difference. The acoustic value often increases in a tooth or sharp peak shape. For an oblique fracture, the logging curves show a decrease in the resistivity and a slight increase in the acoustic value.

(2) Identify a high-angle fracture. If a high-angle fracture has a low development degree and is mostly filled, a bedrock feature is shown in an entire logging curve, with no obvious response. When the high-angle fracture opens, there is a negative difference between the deep and shallow resistivity of the fracture.

Step 6: Identify a development degree of large and small-scale open fractures based on the scale and aperture constraints: measure the large-scale fracture by a fracture linear density, and divide the small-scale fracture based on high and low development degrees by a fracture porosity derived from a thin section, where a conventional logging curve shows that for both the large and small-scale fractures, a higher development degree leads to a more obvious decrease in the resistivity, and an acoustic value tends to increase as the development degree increases.

(1) Identify the development degree of the small-scale fracture: divide the development degree of the small-scale fracture into high and low based on a fracture porosity of 1%. The development degree of micro and small-scale fractures is high, and a cutoff value of log R_{T}−log R_{XO} is 0.1.

(2) Identify the development degree of the large-scale fracture. An analysis finds that the fracture linear density has a good positive correlation with (log R_{b}−log R_{T})/log R_{b}. A greater linear density indicates a greater decrease in the resistivity than the bedrock resistivity. At the same level of acoustic value, a higher fracture linear density indicates a lower resistivity.

The above described are merely preferred specific implementations of the present disclosure, and the protection scope of the present disclosure is not limited thereto. Within the technical scope of the present disclosure, any equivalent substitutions or changes made by those skilled in the art according to the technical solutions and concepts of the present disclosure should be covered by the protection scope of the present disclosure.

What is claimed is:

1. A fine identification method of a tight reservoir fracture based on conventional logging data, comprising the following steps:
step 1: eliminating an influencing factor of a non-fracture response in a logging curve;
step 2: constraining a lithology of a fracture development section, wherein the lithology is a background of a logging curve response and controls fracture development; analyzing a basic lithology of a tight reservoir by core and thin section observation and lithification means, wherein the lithology of the tight reservoir mainly comprises limestone, dolomite, sandstone and mudstone;
choosing a thick, lithologically developed and stable section, eliminating interference of different lithologies, and looking for a stable logging response background with fracture development;
step 3: identifying a fracture scale: performing a more refined interpretation of a fracture based on a fracture scale that can be identified by conventional logging, that is, constraining the fracture scale;
step 4: dividing the fracture into large and small-scale fractures, and identifying a fracture aperture and filling; determining an aperture of the large-scale fracture by a relative amplitude difference between a deep resistivity Rt and a bedrock resistivity Rb, and roughly determining an aperture of the small-scale fracture by a relative difference of deep and shallow lateral resistivity;
step 5: identifying occurrence of a large-scale open fracture based on the scale and aperture constraints, the fracture being divided into high-angle, low-angle and horizontal fractures; and
step 6: identifying a development degree of large and small-scale open fractures based on the scale and aperture constraints: measuring the large-scale fracture by a fracture linear density, and dividing the small-scale fracture based on high and low development degrees by a fracture porosity derived from a thin section, wherein a conventional logging curve shows that for both the large and small-scale fractures, a higher development degree leads to a more obvious decrease in the resistivity, and an acoustic value tends to increase as the development degree increases.

2. The fine identification method of a tight reservoir fracture based on conventional logging data according to claim 1, wherein the step 1 of eliminating an influencing factor of a non-fracture response in a logging curve comprises:
(1) eliminating a thin layer response;
(2) eliminating a shale response; and
(3) eliminating a well wall stability response.

3. The fine identification method of a tight reservoir fracture based on conventional logging data according to claim 1, wherein step 3 of identifying a fracture scale: performing a more refined interpretation of a fracture based on a fracture scale that can be identified by conventional logging, that is, constraining the fracture scale comprises:
(1) dividing the fracture scale: dividing the fracture scale into large, small and micro scales by combining core, thin section, scanning electron microscopy and other means;
(2) identifying a large-scale fracture, wherein under a high-resistivity background, the resistivity shows a tooth-like and finger-like decrease trend, and the resistivity after the decrease is medium-high and less than 3000 Ω·m; an ultrasonic curve often tends to increase, with an acoustic value of greater than 48 μs/ft;
(3) identifying a small-scale fracture, wherein a resistivity is about 6000 Ω·m, and an acoustic value is low; compared with a bedrock background, a resistivity curve shows a tooth-like downward trend, and often drops into a gap, which is a “platform gap”; and
(4) identifying a micro-scale fracture, wherein thick limestone has a finger-like resistivity and a small fracture porosity; the resistivity is equal to or close to the bedrock resistivity; due to lithology and thickness differences, the resistivity is often in high-amplitude, medium-amplitude and low-amplitude finger shapes; a gamma curve background is a box-shaped smooth curve, with a very small increase in a corresponding point; the acoustic value curve is smooth, entirely in a box-shaped background; the resistivity is in a high-amplitude finger shape; since the micro-scale fracture has poor connectivity and conductivity, compared to other rock layer with good connectivity or high shale content, the resistivity in a micro-scale fracture development section is in a finger shape.

4. The fine identification method of a tight reservoir fracture based on conventional logging data according to claim 1, wherein the step 4 of dividing the fracture into large and small-scale fractures, and identifying a fracture aperture and filling: determining an aperture of the large-scale fracture by a relative amplitude difference between a deep resistivity Rt and a bedrock resistivity Rb, and roughly determining an aperture of the small-scale fracture by a relative difference of deep and shallow lateral resistivity comprises:
(1) identifying the aperture of the large-scale fracture, wherein when the fracture opens, (log R_{b}−log R_{T})/log R_{b} increases, >0.05; when the fracture closes, a deep resistivity of the fracture is very close to the bedrock resistivity, and (log R_{b}−log R_{T})/log R_{b}<0.05;
(2) calibrating the small-scale fracture only through a thin section, wherein the aperture of the small-scale fracture is only roughly identified based on RT, with a poor identification effect; and
(3) identifying the fracture filling, wherein a gamma ray (GR) intensity of a shale-filled fracture is significantly higher than that of a calcite-filled fracture, with a dividing line being 20 API; acoustic (AC) logging has a poor identification effect on the filling; the acoustic value of the shale-filled fracture is greater, up to 63 μs/ft, which is equivalent to that of an open fracture; the Rt of the calcite-filled fracture is significantly greater than that of the shale-filled fracture; the resistivity of the shale-filled fracture is higher than an unfilled open fracture; an unfilled fracture has a slightly higher gamma value and a lower resistivity than a filled fracture.

5. The fine identification method of a tight reservoir fracture based on conventional logging data according to claim 1, wherein the step 5 of identifying occurrence of a large-scale open fracture based on the scale and aperture constraints, the fracture being divided into high-angle, low-angle and horizontal fractures comprises:
(1) identifying low-angle and horizontal fractures, wherein the natural gamma logging curve is box-shaped and smooth; the resistivity often reduces in a sharp peak shape or a tooth shape, with no amplitude difference to slight negative amplitude difference; the acoustic value often increases in a tooth or sharp peak shape; for an oblique fracture, the logging curves show a decrease in the resistivity and a slight increase in the acoustic value; and
(2) identifying a high-angle fracture, wherein if a high-angle fracture has a low development degree and is mostly filled, a bedrock feature is shown in an entire logging curve, with no obvious response; when the high-angle fracture opens, there is a negative difference between the deep and shallow resistivity of the fracture.

6. The fine identification method of a tight reservoir fracture based on conventional logging data according to claim 1, wherein the step 6 of identifying a development degree of large and small-scale open fractures based on the scale and aperture constraints: measuring the large-scale fracture by a fracture linear density, and dividing the small-scale fracture based on high and low development degrees by a fracture porosity derived from a thin section, wherein a conventional logging curve shows that for both the large and small-scale fractures, a higher development degree leads to a more obvious decrease in the resistivity, and an acoustic value tends to increase as the development degree increases comprises:
(1) identifying the development degree of the small-scale fracture: dividing the development degree of the small-scale fracture into high and low based on a fracture porosity of 1%, wherein the development degree of micro and small-scale fractures is high, and a cutoff value of log R_{T}−log R_{XO} is 0.1; and
(2) identifying the development degree of the large-scale fracture, wherein an analysis finds that the fracture linear density has a good positive correlation with (log R_{b}−log R_{T})/log R_{b}; a greater linear density indicates a greater decrease in the resistivity than the bedrock resistivity; at the same level of acoustic value, a higher fracture linear density indicates a lower resistivity.
